(19) United States
(12) Patent Application Publication
(10) Pub. No.: US 2011/0172361 A1
(43) Pub. Date: Jul. 14, 2011

(54) METHODS FOR SYNTHESIZING POLYTRIMETHYLENE ETHER GLYCOL AND COPOLYMERS THEREOF

(75) Inventors: Edward Budi Muliawan, Kingston (CA); Tuyu Xie, Kingston (CA)

(73) Assignee: E.I. DU PONT DE NEMOURS AND COMPANY, Wilmington, DE (US)

(21) Appl. No.: 12/837,564

(22) Filed: Jul. 16, 2010

Related U.S. Application Data
(60) Provisional application No. 61/227,518, filed on Jul. 22, 2009.

(51) Int. Cl. C08G 65/48; C08G 65/34

(52) U.S. Cl. 525/50; 528/425; 528/381

(57) ABSTRACT

Processes for synthesizing polytrimethylene ether glycol and copolymers thereof are provided. The processes include polycondensing diols in the presence of carbon black, and may be used to produce polymers having molecular weights from about 250 to about 5000.

### CROSS-REFERENCE TO RELATED APPLICATIONS

This application claims the benefit of Provisional U.S. Application Ser. No. 61/227,522.

### FIELD OF THE INVENTION

The invention relates to methods for synthesizing polytrimethylene ether glycol and copolymers thereof. The methods provide reduced color as compared to such polymers made using conventional methods.

### BACKGROUND

Polytrimethylene ether glycol (hereinafter also referred to as “PO3G”) produced from the acid catalyzed polycondensation of 1,3-propanediol (hereinafter also referred to as “PDO”) can have quality problems, in particular the color of the polymer may not be acceptable to the industry. The raw material PDO and the polymerization process conditions and stability of the polymer are responsible for discoloration to some extent.

Various pre-polymerization treatment methods are disclosed in the prior art to remove color precursors present in the PDO. Attempts have also been made to reduce the color of polytrimethylene ether glycols post-polymerization. For example, Sunkara et al. describes a process for reducing color in PO3G by contacting PO3G with an adsorbent and then separating the PO3G from the adsorbent (U.S. Pat. No. 7,294,746).

Pre- or post-polymerization methods may undesireably add additional steps, time, and expense to production processes. Attempts have also been made to alter reaction conditions to control product color during polymerization. For example, U.S. Patent Application Publication No. 2005/272911 discloses methods of controlling color formation by carrying out the dehydration-condensation reaction in the presence of a catalyst composed of an acid and a base.

There exists a need for improved and convenient methods to reduce color of PO3G.

### BRIEF DESCRIPTION OF THE FIGURES

FIG. 1 illustrates the molecular weight development of 1,3-propanediol polymerization with and without carbon black addition.

FIG. 2 illustrates PO3G product color development as a function of molecular weight with and without carbon black during polymerization.

### SUMMARY OF THE INVENTION

One aspect of the present invention is a process comprising polycondensing reactants comprising 1,3-propanediol, poly-1,3-propanediol or a mixture thereof in the presence of acid polycondensation catalyst and carbon black to form a reaction product.

### DETAILED DESCRIPTION

Unless otherwise stated, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed.

Processes disclosed herein employ carbon black. Carbon black is an adsorbent, and although it is present during reactions in the processes described herein, it is not a “reactant” as the term is used herein. The term “adsorbent” refers to materials that commonly are used to remove relatively small amounts of undesired components, whether such removal is by the process of adsorption or absorption. As used herein, “carbon black” refers to carbon black, activated carbon, or charcoal. Activated carbon is available commercially in different forms such as powder, granular, and shaped products. The preferred form is powdered activated carbon. Various brands of carbon may be used, including, but not limited to, Norit America G60, NORIT RO 0.8, Calgon PWA, BL, and WPH, and Ceca ACTICARBONE ENO. Also suitable are Darco KB-G or Darco S-51 (Norit), or ADP Carbon (Calgon Carbon). Suitable forms of carbon black also include those having a particle size range of about 2.7 micron to about 130 micron. Other forms will be known to those skilled in the art.

Other adsorbents suitable for the processes disclosed herein are commercially available from various sources and in many forms and include alumina, silica, diatomaceous earth, montmorillonite clays, Fuller's earth, kaolin minerals and derivatives thereof.

“Color” and “color bodies” refer to visible color that can be quantified by the use of a spectrocolorimeter in the range of visible light, using wavelengths of approximately 400 to 800 nm, and by comparison with pure water. Color precursors in PDO are not visible in this range, but contribute color during and after polymerization.

Provided herein is a process of producing polymeric reaction product in the presence of carbon black. The processs comprises polycondensing reactants comprising 1,3-propanediol, poly-1,3-propanediol or a mixture thereof in the presence of acid polycondensation catalyst and carbon black to form a reaction product. In some embodiments, the process further comprises separating the reaction product from the carbon black. In some embodiments, the reactants further comprise a comonomer diol.

In some embodiments, the reaction product has a molecular weight greater than about 500 or a molecular weight of about 500 to about 5000. In some embodiments, the reaction product has an APHA color of less than about 250 or less than about 50.

In some embodiments, the reaction product comprises polytrimethylene ether glycol. In some embodiments, the polytrimethylene ether glycol is contacted with a monocarboxylic acid to form a dicarboxylic acid ester of polytrimethylene ether glycol.

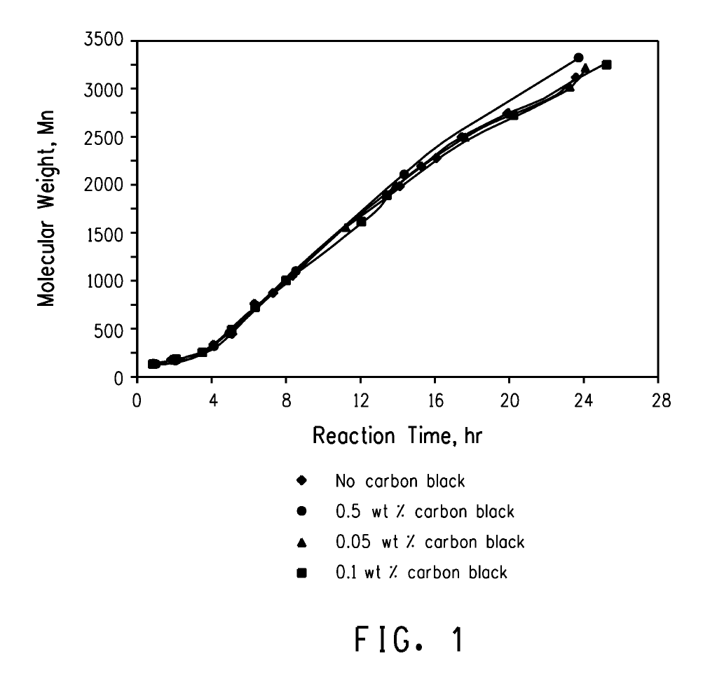

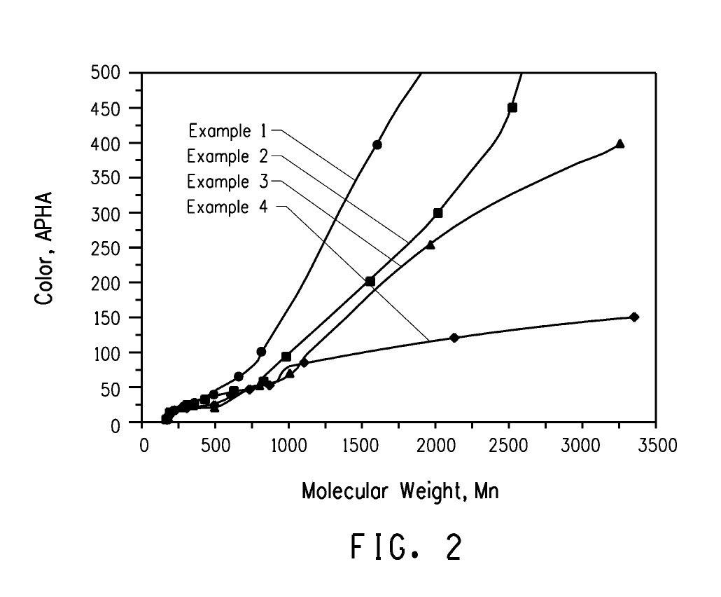

In accordance with the present invention, it has been found that carbon black reduces polymer color when present during polymerization (FIG. 2, Examples). In preferred embodiments, the carbon black has a desirable effect on polymer color without substantially affecting polymer molecular weight development (FIG. 1, Examples). At the same reaction temperature and acid concentration, for a given polymer molecular weight, polymer color decreases with an increase in amount of carbon black addition. Also, in situ removal of color species may allow a polymerization process to be operated at a higher temperature and higher catalyst concentrations facilitating production of a certain molecular weight product in a shorter polymerization time period.

In one embodiment, a process comprises contacting reactants with a catalyst and carbon black to form a reaction product, wherein said reactants comprise at least one of:

(a) a diol of formula OH(CH₂)ₙOH where n is an integer greater than or equal to 2, or a polyol thereof; or
(b) a diacid of formula HOOC(CH₂)_{z}COOH where z is an integer greater than or equal to 4, or a polymer thereof.

Also provided is a process comprising contacting reactants with a catalyst and carbon black to form a polyester diol reaction product wherein the reactants comprise both

(a) a diol of formula OH(CH₂)ₙOH where n is an integer greater than or equal to 2 or a polyol thereof; and
(b) a diacid of formula HOOC(CH₂)_{z}COOH where z is an integer greater than or equal to 4 or a polymer thereof.

Further provided is a process comprising contacting reactant with a catalyst and carbon black to form a polyether diol reaction product wherein the reactants comprise a diol of formula OH(CH₂)ₙOH where n is an integer greater than or equal to 3 or polyols thereof; or a diol of formula HOOC(CH₂)_{z}COOH where z is an integer greater than or equal to 6 or polyols thereof.

Also disclosed is a process comprising contacting reactants with a catalyst and carbon black to form a reaction product wherein the reactants comprise a diol of formula OH(CH₂)ₙOH where n is an integer greater than or equal to 2, or polyols thereof; and wherein said diol is 1,3-propane diol. In another aspect, the reactants further comprise a comonomer diol. In one embodiment, the reaction product comprises polytrimethylene ether glycol.

In some embodiments, the carbon black is about 0.05 to about 5 weight percent based on the total weight of the reactants. In some embodiments, the process includes separating the reaction product from the carbon black by, for example, filtration.

In some embodiments, the catalyst for the processes comprises a titanium catalyst or an acid catalyst. In some embodiments, the reaction products of the processes have an APHA color of less than about 250, less than about 100, less than about 50, less than about 40, or less than about 30.

Also provided is a process comprising polycondensing reactants comprising 1,3-propanediol, poly-1,3-propanediol or a mixture thereof, in the presence of acid and carbon black. In one embodiment, the reaction product comprises polytrimethylene ether glycol. In some embodiments, the 1,3-propanediol, the poly-1,3-propanediol or mixtures thereof comprise bio-derived 1,3-propanediol. In some aspects the acid comprises sulfuric acid. In further embodiments the reactants comprise comonomer diol and the comonomer diol can, in some embodiments, be ethylene glycol.

In some embodiments, the process further comprises contacting the polytrimethylene ether glycol with a monocarboxylic acid to form a dicarboxylic acid ester of polytrimethylene ether glycol. In some aspects, the monocarboxylic acid is 2-ethylhexanoic acid.

In some embodiments, the molecular weight of the reaction product is greater than about 500. In some preferred embodiments, the molecular weight is from about 500 to about 5000. In some embodiments, the product has an APHA color of less than about 250, less than about 100, less than about 50, less than about 40 or less than about 30.

The processes disclosed herein can, in some embodiments, be used to make polytrimethylene ether glycol.

In the processes disclosed herein, carbon black may be added at any time during the polycondensation reaction. Depending on the reaction conditions and the time of addition, the reactants present during the polycondensation in the presence of carbon black can include monomer diols or polyols thereof, or diacids or polymers thereof. In one example, the reactants comprise PDO monomer, poly-1,3-propanediol, or mixtures thereof. Poly-1,3-propanediol includes oligomers of PDO including PDO dimer and PDO trimer.

The processes disclosed herein can be used to produce reaction products from reactants comprising at least one of a diol of formula OH(CH₂)ₙOH where n is an integer greater than or equal to 2, or a polyol thereof; or a diacid of formula HOOC(CH₂)_{z}COOH where z is an integer greater than or equal to 4, or a polymer thereof. The reactants can include both a diol (or a polyol thereof) and a diacid (or a polymer thereof) such as, for example, when the reaction product is a polyester diol. Reaction products may be homopolymers or copolymers.

Polyester diol reaction products can be prepared using known methods from aliphatic, cycloaliphatic or aromatic dicarboxylic or polycarboxylic acids or anhydrides thereof (for example, succinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic or trimellitic acid) as well as acid anhydrides (such as o-phthalic, trimellitic or succinic acid anhydride or a mixture thereof) and dihydric alcohols such as, for example, ethanediol, diethylene, triethylene, tetraethylene glycol, 1,2-propanediol, dipropylene, tripropylene, tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol or mixtures thereof.

Diols suitable for the processes disclosed herein include aliphatic diols, for example, ethylenediol, 1,6-hexanediol, 1,7-heptanediol, 1,8-octanediol, 1,9-nonanediol, 1,10-decanediol, 1,12-dodecanediol, 3,3,4,4,5,5-hexafluoro-1,5-pentanediol, 2,2,3,3,4,4,5,5-octafluoro-1,6-hexanediol, 3,3,4,4,5,5,6,6,7,7,8,8,9,9,10,10-hexadecafluoro-1,12-dodecanediol, cycloaliphatic diols, for example, 1,4-cyclohexanediol, 1,4-cyclohexanedimethanol and isosorbide, polyhydroxy compounds, for example, glycerol, trimethylolpropane, and pentaerythritol. Other suitable diols include 2-methyl-1,3-propanediol, 2,2-dimethyl-1,3-propanediol, 2,2-diethyl-1,3-propanediol, 2-ethyl-2-(hydroxymethyl)-1,3-propanediol, 1,6-hexanediol, 1,8-octanediol, 1,10-decanediol, isosorbide, and mixtures thereof. In some embodiments, preferred diols are 1,3-propanediol and ethylene glycol.

Catalysts suitable for the production of polyester diols include organic and inorganic compounds of titanium, lanthanum, tin, antimony, zirconium, manganese, zinc, phosphorus and mixtures thereof. Titanium catalysts such as tetraisopropyl titanate and tetrabutyl titanate are preferred and can be added in an amount of at least about 25 ppm and up to about 1000 ppm titanium by weight, based on the weight of the polymer.

The processes disclosed herein can be used to produce polyether diol reaction products. For example the processes can be used to produce reaction products from reactants comprising at least one of a diol of formula OH(CH₂)ₙOH where n is an integer greater than or equal to 3, or a polyol thereof; or a diol of formula OH(CH₂)ₙOH where n is an integer greater than or equal to 6, or a polyol thereof. Diols of formula OH(CH₂)ₙOH where n is 2, 4, or 5 may not be preferred, as they may cyclize.

In one embodiment, the reaction product comprises PO3G. Methods of making PO3G from 1,3-propanediol are described in the art, for example, in U.S. Application Publication Nos. 20020007043 and 20020010374. As shown in the Examples herein, polyether diols such as PO3G can be produced by polycondensing PDO using an acid catalyst. Suitable catalysts for processes to produce polyether diols include those acids with a pKa less than about 4, preferably with a pKa less than about 2, and include inorganic acids, organic sulfonic acids, heteropolyacids, perfluoro-alkyl sulfonic acids and mixtures thereof. Also suitable are metal salts of acids with a pKa less than about 4, including metal sulfonates, metal trifluoroacetates, metal triflates, and mixtures thereof including mixtures of the salts with their conjugate acids. Specific examples of catalysts include sulfuric acid, fluorosulfonic acid, phosphorous acid, p-toluenesulfonic acid, benzenesulfonic acid, phosphotungstic acid, phosphomolybdic acid, trifluoromethanesulfonic acid, 1,1,2,2-tetrafluoroethanesulfonic acid, 1,1,1,2,3,3-hexafluoropropanesulfonic acid, bismuth triflate, yttrium triflate, ytterbium triflate, neodymium triflate, lanthanum triflate, scandium triflate, zirconium triflate. A preferred catalyst for PO3G is sulfuric acid. Other suitable catalysts include superacids and NAFION solid catalysts (E.I. DuPont de Nemours & Co.).

A particularly preferred source of PDO is via a fermentation process using a renewable biological source. As an illustrative example of a starting material from a renewable source, biochemical routes to PDO have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including U.S. Pat. No. 5,633,362, U.S. Pat. No. 5,686,276 and U.S. Pat. No. 5,821,092. U.S. Pat. No. 5,821,092 discloses, inter alia, a process for the biological production of PDO from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and PDO is isolated from the growth media. Since both bacteria and yeasts can convert glucose (e.g., corn sugar) or other carbohydrates to glycerol, the processes disclosed in these publications provide a rapid, inexpensive and environmentally responsible source of PDO monomer.

The biologically-derived PDO, such as produced by the processes described and referenced above, contains carbon from the atmospheric carbon dioxide incorporated by plants, which compose the feedstock for the production of the PDO. In this way, the biologically-derived PDO preferred for use in the context of the present invention contains only renewable carbon, and not fossil fuel-based or petroleum-based carbon. The polymers based thereon utilizing the biologically-derived PDO, therefore, have less impact on the environment as the PDO used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

Preferably the PDO used as a reactant or as a component of the reactants in the processes disclosed herein has a purity of greater than about 99%, and more preferably greater than about 99.9%, by weight as determined by gas chromatographic analysis. Particularly preferred is purified PDO as disclosed in U.S. Pat. No. 7,098,368, U.S. Pat. No. 7,084,311 and US20050069997A1

In one embodiment the product of the process is PO3G. Product PO3G can be PO3G homo- or co-polymer. For example, the PDO can be polymerized with other diols (“comonomer diols”) to make copolymer. The PDO copolymers useful in the process can contain up to 50 percent by weight (preferably 20 percent by weight or less) of comonomer diols in addition to the 1,3-propanediol and/or its oligomers. A preferred comonomer diol is ethylene glycol. Other comonomer diols that are suitable for use in the process include aliphatic diols, for example, ethylenediol, 1,6-hexanediol, 1,7-heptanediol, 1,8-octanediol, 1,9-nonanediol, 1,10-decanediol, 1,12-dodecanediol, 3,3,4,4,5,5-hexafluoro-1,5-pentanediol, 2,2,3,3,4,4,5,5-octafluoro-1,6-hexanediol, 3,3,4,4,5,5,6,6,7,7,8,8,9,9,10,10-hexadecafluoro-1,12-dodecanediol, cycloaliphatic diols, for example, 1,4-cyclohexanediol, 1,4-cyclohexanedimethanol and isosorbide, polyhydroxy compounds, for example, glycerol, trimethylolpropane, and pentaerythritol. Other suitable comonomer diols are selected from the group consisting of 2-methyl-1,3-propanediol, 2,2-dimethyl-1,3-propanediol, 2,2-diethyl-1,3-propanediol, 2-ethyl-2-(hydroxymethyl)-1,3-propanediol, 1,6-hexanediol, 1,8-octanediol, 1,10-decanediol, isosorbide, and mixtures thereof. Thermal stabilizers, antioxidants and coloring materials may be added to the polymerization mixture or to the polymer if desired.

In one embodiment, a process comprises causing reactants to polymerize in the presence of carbon black. For a given reaction temperature and catalyst concentration, product APHA color values for a polymer of a given molecular weight or molecular weight range are reduced as compared to the color values for the product polymerized without the presence of carbon black. It will be appreciated that preferred color values or preferred reductions may vary depending on the desired molecular weight or the desired end use of the product. However, armed with this disclosure, one of skill in the art will be able to adjust the process conditions to achieve the desired effect on the color of the product.

It is desired that reaction in the presence carbon black results in polymer with an APHA color of less than about 100, and, more preferably, less than 50. Preferably, the APHA color is less than about 40, more preferably, less than 30. So, in certain embodiments, the APHA color is about 30 to about 100 APHA. APHA color values are a measure of color as defined in ASTM-D-1209 (see Test Method 1, below).

The molecular weight of the product polymer is typically within the range of about 250 to about 5000. Preferably, the molecular weight is about 500 to about 4000. In some embodiments, the product polymer has a molecular weight of about 250 to about 2250. In some embodiments the product polymer has a molecular weight of about 1000 to 2250.

The amount of carbon black used depends on factors including the process conditions such as reaction volume, contact time and temperature. Carbon black can be added at any time during the reaction, but is preferably added at the beginning of the reaction. It can be premixed with reactant or catalyst before addition into the reactor. The amount added may be based on the weight of the monomer or polymer phase at the time of addition. For example, if the reactants comprise PDO and comonomer, the amount will be based on the total weight of PDO and comonomer initially added. For continuous operations, it should be based on the total weight of reactants in the reactor.

About 0.05 to about 5 weight percent carbon black may be employed, and about 0.1 to about 1 weight percent carbon black is preferred. It is preferred that the amount added is sufficient to reduce color, and preferably the amount added is sufficient to reduce color to less than 100 APHA or more preferably to less than 50 APHA.

The contacting of the reactants with carbon black is carried out under conditions suitable for polymerization. The contacting occurs in the presence of acid and preferably at a temperature of about 120 to 220° C., preferably 150 to 180° C. The reaction is conducted for a period of about 3 to 50 hours, and preferably about 3 to about 15 hours.

Suitable processes for removal of the carbon black such as filtration are well known to those skilled in the art. Other filter media can be used and will be well known to those skilled in the art, the requirements being a fineness of filter sufficient to retain the carbon black and inert to the glycol.

A batch process can be used, wherein carbon black is added into the reactor at any stage of reaction, and, after a period of time, separated out by suitable means, for example, by filtration, centrifugation, etc. The process of the invention may also be conducted in a continuous or semi-continuous fashion. For example, the reactants may be mixed with carbon black and be pumped from a storage tank into a reactor. Carbon black can be added into the reactor at any stage of reaction. The feed rate is adjusted for the kind, amount, and prior use of carbon black in the bed and the color level of the feedstock so that the carbon black is present in the reactor sufficiently long to give a product with the desired color reduction. Other variations will be recognized by those skilled in the art. Although it is contemplated that the process described herein can be used in conjunction with methods known in the art wherein the raw materials are pretreated to remove color (such as, for example, in U.S. Pat. No. 6,235,948), or methods wherein the polymer products are post-treated to remove color (such as, for example, in U.S. Pat. No. 7,294,746) it is also believed that use of the process described herein eliminate or diminish the necessity of such pretreatment steps and still produce polymer of desired low APHA color. In some embodiments, the product has desired APHA color at the end of the polymerization, and in other embodiments, the product achieves desired APHA color after further purification. The processes disclosed herein can be used for the decolorization of PO3G prepared by polymerization of PDO prepared from petrochemical sources, such as the process using acrolein, and for PO3G prepared by polymerization of PDO prepared by biochemical routes.

In accordance with a further embodiment of the present invention, a product comprises (i) carbon black, and (ii) PO3G wherein the PO3G has an APHA color of less than about 250. In certain embodiments, the APHA color is less than about 100, less than about 50, less than about 40, or less than about 30. Also, the product may contain about 0.05 to about 5 weight percent of carbon black or preferably about 0.1 to about 1 weight percent of carbon black.

In one embodiment, the process forms PO3G and further comprises esterification of the product PO3G by reaction with a monocarboxylic acid and/or equivalent, as described in copending U.S. Application Publication No. 20080108845. By “monocarboxylic acid equivalent” is meant compounds that perform substantially like monocarboxylic acids in reaction with polymeric glycols and diols, as would be generally recognized by a person of ordinary skill in the relevant art. Monocarboxylic acid equivalents for the purpose of the present invention include, for example, esters of monocarboxylic acids, and ester-forming derivatives such as acid halides (e.g., acid chlorides) and anhydrides. Preferably, a monocarboxylic acid is used having the formula R—COON, wherein R is a substituted or unsubstituted aromatic, aliphatic or cycloaliphatic organic moiety containing from 6 to 40 carbon atoms. Mixtures of different monocarboxylic acids and/or equivalents are also suitable.

The monocarboxylic acid (or equivalent) can contain any substituent groups or combinations thereof (such as functional groups like amide, amine, carbonyl, halide, hydroxyl, etc.), so long as the substituent groups do not interfere with the esterification reaction or adversely affect the properties of the resulting ester product.

Suitable monocarboxylic acids and their derivatives include lauric, myristic, palmitic, stearic, arachidic, benzoic, caprylic, palmitic, erucic, palmitoleic, pentadecanoic, heptadecanoic, nonadecanoic, linoleic, arachidonic, oleic, valeric, caproic, capric and 2-ethylhexanoic acids, and mixtures thereof. In a preferred embodiment, the monocarboxylic acid is 2-ethylhexanoic acid. In some embodiments, the dicarboxylic acid esters produced by the processes provided herein, in particular the bis-2-ethylhexanoate esters will have uses as functional fluids, for example, as lubricants.

For preparation of the carboxylic acid esters, the PO3G can be contacted, preferably in the presence of an inert gas, with the monocarboxylic acid(s) at temperatures ranging from about 100° C. to about 275° C., from about 120° C. to 250° C., and most preferably at about 120° C. The process can be carried out at atmospheric pressure or under vacuum. During the contacting water is formed and can be removed in the inert gas stream or under vacuum to drive the reaction to completion.

To facilitate the reaction of PO3G with carboxylic acid an esterfication catalyst is generally used, preferably an acid catalyst. Examples of suitable acid catalysts include but are not limited to sulfuric acid, hydrochloric acid, phosphoric acid, hydriodic acid. Other suitable catalysts include heterogeneous catalysts such as zeolites, heteropolyacid, amberlyst, and ion exchange resin. A particularly preferred acid catalyst is sulfuric acid. The amount of catalyst used in the contacting of PO3G with monocarboxylic acid can be from about 0.01 wt % to about 10 wt % of the reaction mixture, preferably from 0.1 wt % to about 5 wt %, and more preferably from about 0.2 wt % to about 2 wt %, of the reaction mixture.

Any ratio of monocarboxylic acid, or derivatives thereof, to glycol hydroxyl groups can be used. The preferred ratio of acid to hydroxyl groups is from about 3:1 to about 1:2, where the ratio can be adjusted to shift the ratio of monoester to diester in the product. Generally to favor production of diesters slightly more than a 1:1 ratio is used. To favor production of monoesters, a 0.5:1 ratio or less of monocarboxylic acid to hydroxyl is used.

A preferred process comprises polycondensing 1,3-propanediol in the presence of carbon black to polytrimethylene ether glycol using an acid catalyst (as described herein), then subsequently adding monocarboxylic acid and carrying out the esterification to form a dicarboxylic acid ester of PO3G. It is preferred that the contacting of PO3G with a monocarboxylic acid is carried out without first isolating and purifying the PO3G.

The polycondensation reaction is continued until desired molecular weight is reached, and then the monocarboxylic acid is subsequently added to the reaction mixture. The reaction is continued while the water byproduct is removed. At this stage both esterification and etherification reactions occur simultaneously. Thus, in a preferred process, the acid catalyst used for polycondensation of diol is also used for esterification without adding additional catalyst. However, it is contemplated that additional catalyst can be added at the esterification stage.

In an alternative procedure, the esterification reaction can be carried out on purified PO3G by addition of an esterification catalyst and monocarboxylic acid followed by heating and removal of water. Regardless of which esterification procedure is followed, after the esterification step any by products are removed, and then the catalyst residues remaining from polycondensation and/or esterification are removed in order to obtain an ester product that is stable, particularly at high temperatures. This may be accomplished by hydrolysis of the crude ester product by treatment with water at from about 80° C. to about 100° C. for a time sufficient to hydrolyze any residual acid esters derived from the catalyst without impacting significantly the carboxylic acid esters. The time required can vary from about 1 to about 8 hours. If the hydrolysis is carried out under pressure, higher temperatures and correspondingly shorter times are possible. At this point the product may contain diesters, monoesters, or a combination of diesters and monoesters, and small amounts of acid catalyst, unreacted carboxylic acid and diol depending on the reaction conditions. However, dicarboxylic acid esters are preferred, and processes which produce dicarboxylic acid esters are preferred.

The hydrolyzed polymer is further purified to remove water, acid catalyst and unreacted carboxylic acid by the known conventional techniques such as water washings, base neutralization, filtration and/or distillation. Unreacted diol and acid catalyst can, for example, be removed by washing with deionized water. Unreacted carboxylic acid also can be removed, for example, by washing with deionized water or aqueous base solutions, or by vacuum stripping). If desired, the product can be fractionated further to isolate low molecular weight esters by a fractional distillation under reduced pressure.

### EXAMPLES

### Materials, Equipment, and Test Methods

The bio-derived PDO used in the Examples herein is commercially available from E.I. DuPont de Nemours & Co. as DuPont Tate & Lyle Bio-PDO™. For Examples 2, 3, and 4, carbon black (Norit Carbon) was obtained from Univar (product name Darco® G-60). For examples 6, and 7, carbon black was type ADP carbon (Calgon Carbon).

### Test Method 1

### Color Measurement and APHA Values

A Hunterlab Color Quest XE Spectrocolorimeter (Reston, Va.) was used to measure the polymer color resulting from the absence or presence of carbon black treatment. Color numbers of the polymer are measured as APHA values (Platinum-Cobalt System) according to ASTM D-1209. The polymer molecular weights were calculated from their hydroxyl numbers obtained from NMR or were determined using a previously generated standard curve based on polymer viscosity.

### Comparative Example A

### Control Polymerization

12 kg of bio-based PDO monomer was added to a 20 L glass reactor equipped with a condenser and an agitator, purged with N₂ at the rate 5 L/min. The reactant was heated up to 170° C. with agitation speed of 250 rpm. When the reactant temperature reached 170° C., 187.5 g of sulfuric acid was added into the reactor. The time of sulfuric acid addition was set as reaction starting point. Polymerization proceeded at 170° C. The reaction volatiles were condensed in the condenser and the polymer product was accumulated in the reactor. Polymer samples were taken periodically for color and molecular weight analysis. The number average molecular weight of polymer was determined by NMR and the product color was determined using a Hunter Lab Color quest XE machine and expressed as APHA index. Molecular weight development is shown in FIG. 1 and product color is shown in FIG. 2.

### Example 1

### 0.05 Weight Percent of Carbon Black

The equipment and polymerization procedures were the same as in Comparative Example A except for carbon black addition. 0.05 weight percent of carbon black (Darco® G-60, Univar) on the basis of bio-based PDO was added together with the monomer at the beginning of the polymerization. Carbon black was mixed with monomer under agitation when the reactor temperature was increased to 170° C. 187.5 g of sulfuric acid was added at 170° C. and the polymerization occurred in the present of carbon black. Product molecular weight and color were measured after carbon black removal by filtration at ambient temperature using a syringe filter. The product color was measured by visual comparison of the samples with a series of standard samples determined using a Hunter Lab Color quest XE machine and expressed as APHA index. The molecular weight and color developments are shown in FIGS. 1 and 2 respectively.

### Example 2

### 0.1 Weight Percent of Carbon Black

The equipment and polymerization procedures were the same as in Example 1 except for amount of carbon black addition. 0.1 weight percent of carbon black on the basis of bio-based PDO was added together with the monomer at the beginning of the polymerization. The molecular weight and color developments are shown in FIGS. 1 and 2 respectively.

### Example 3

### 0.5 Weight Percent of Carbon Black

The equipment and polymerization procedures were the same as in Example 1 except for amount of carbon black addition. 0.5 weight percent of carbon black on the basis of bio-based PDO was added together with the monomer at the beginning of the polymerization. The molecular weight and color developments are shown in FIGS. 1 and 2 respectively.

### Comparative Example B

### Control Polymerization

900 g of bio-based PDO monomer, 11.5 g of 0.98 percent purity sulfuric acid, and 6.1 g of 10 weight percent sodium carbonate solution in demineralized water (for color control) were added to a 1 L glass reactor equipped with a condenser and an agitator, purged with N₂ at the rate of 35 L/min. The reactant was heated up to 170° C. with agitation speed of 120 rpm. The time the heat was turned on was set as the reaction starting point. Polymerization proceeded at 170° C. The reaction volatiles were condensed in the condenser and polymer product was accumulated in the reactor. The polymer samples were taken periodically for molecular weight analysis, using a viscometer. The total reaction time is 18 hours. The number average molecular weight of polymer was determined from its viscosity, which is calibrated based on NMR measurements. The product color was determined using Hunter Lab Color quest XE machine and expressed as APHA index. The molecular weight and color of final crude polymer are shown in Table 1.

### Example 4

### 0.5 Weight Percent of Carbon Black, Added at Reaction Times of 2 and 5 Hours

900 g of bio-based PDO monomer and 11.5 g of 0.98 percent purity sulfuric acid were added to a 1 L glass reactor equipped with a condenser and an agitator, purged with N₂ at the rate of 35 L/min. The reactant was heated up to 170° C. with agitation speed of 120 rpm. The time the heat was turned on was set as the reaction starting point. Polymerization proceeded at 170° C. A mixture of 2 g of carbon black in about 10 g bio-PDO is added into the reaction at reaction times of 2 and 5 hours. The reaction volatiles were condensed in the condenser and polymer product was accumulated in the reactor. The polymer samples were taken periodically for molecular weight analysis, using a viscometer. Total reaction time is 25 hours. The number average molecular weight of polymer was determined from its viscosity. The product color was measured by visual comparison of the samples with a series of standard samples determined using a Hunter Lab Color quest XE machine and expressed as APHA index. The molecular weight and color of final crude polymer are shown in Table 1.

### Example 5

### 0.5 Weight Percent of Carbon Black, Added at Reaction Time of 4 Hours

900 g of bio-based PDO monomer and 11.5 g of 0.98 percent purity sulfuric acid were added to a 1 L glass reactor equipped with a condenser and an agitator, purged with N₂ at the rate of 35 L/min. The reactant was heated up to 170° C. with agitation speed of 120 rpm. The time the heat was turned on was set as the reaction starting point. Polymerization proceeded at 170° C. A mixture of 4 g of carbon black in about 10 g bio-PDO is added into the reaction at reaction time of 4 hours. The reaction volatiles were condensed in the condenser and polymer product was accumulated in the reactor. The polymer samples were taken periodically for molecular weight analysis, using a viscometer. Total reaction time is 25 hours. The number average molecular weight of polymer was determined from its viscosity. The product color was measured by visual comparison of the samples with a series of standard samples determined using a Hunter Lab Color quest XE machine and expressed as APHA index. The molecular weight and color of final crude polymer are shown in Table 1.

TABLE 1
Result summary

| | Heat/Reaction | | Mₙ based on | Color |
|---|---|---|---|---|
| Example | time (hr) | Viscosity (Cp) | viscosity (g/mol) | (APHA) |
| Comp. B | 18 | 7,246 | 3,244 | >500 |
| 4 | 25 | 14,007 | 4,228 | 180 |
| 5 | 25 | 20,444 | 4,836 | 200 |

### Example 6

### (PROPHETIC) Esterification of PO3G

PDO is polymerized to form PO3G homopolymer in the presence of carbon black as described in other Examples. When the reaction product reaches a MW of about 300 (or a viscosity of 150 cP), 2-ethylhexanoic acid is added to the reaction mixture to esterify the PO3G homopolymer. The amount of 2-ethylhexanoic acid added is about 60 wt % of the original PDO charged into the reactor. No additional acid catalyst is added. The temperature is reduced to 120° C., and the reaction is carried out for about 6 to 7 additional hours with no changes in the pressure. The resulting ester product is tested for color as described and is analyzed using proton NMR and IR for MW and % esterification respectively. It is preferred that the color will be below about 200 APHA, and that the % esterification will be at least 80%. The reaction product is then purified by neutralizing the acid and removing the impurities from the product using methods known in the art, for example as in US Pat. Publication 20080108845.

What is claimed is:

1. A process comprising polycondensing reactants comprising 1,3-propanediol, poly-1,3-propanediol or a mixture thereof in the presence of acid polycondensation catalyst and carbon black to form a reaction product.

2. The process of claim 1 further comprising separating the reaction product from the carbon black.

3. The process of claim 1 wherein the carbon black is present in an amount from about 0.05 to about 5 weight percent based on the total weight of the reactants.

4. The process of claim 1 wherein the reaction product comprises polytrimethylene ether glycol.

5. The process of claim 4 further comprising contacting the polytrimethylene ether glycol with a monocarboxylic acid to form a dicarboxylic acid ester of polytrimethylene ether glycol.

6. The process of claim 5 wherein the monocarboxylic acid is 2-ethylhexanoic acid.

7. The process of claim 1 wherein the acid polycondensation catalyst comprises sulfuric acid.

8. The process of claim 1 wherein the reaction product has a molecular weight greater than about 500.

9. The process of claim 1 wherein the reaction product has a molecular weight of about 500 to about 5000.

10. The process of claim 1 wherein the reaction product has an APHA color of less than about 250.

11. The process of claim 1 wherein the reaction product has an APHA color of less than about 50.

12. The process of claim 1 wherein the diol comprises bio-derived 1,3-propanediol.

13. The process of claim 1 wherein the reactants further comprise a comonomer diol.

14. The process of claim 15 wherein the comonomer diol is ethylene glycol

15. Polytrimethylene ether glycol produced by the process of claim 1.
